(19) United States
(12) Patent Application Publication
(10) Pub. No.: US 2003/0104822 A1
(43) Pub. Date: Jun. 5, 2003

(54) Location reporting system utilizing a voice interface

(75) Inventor: Richard Bentley, San Francisco, CA (US)

Correspondence Address: David G. Beck, Bingham McCutchen, LLP, 28th Floor, Three Embarcadero Center, San Francisco, CA, 94111, US

(73) Assignee: TelEvoke Inc., San Francisco, CA (US)

(21) Appl. No.: 10/235,987

(22) Filed: Sep. 5, 2002

Related U.S. Application Data
(63) Continuation-in-part of application No. 09/990,614, filed on Nov. 21, 2001.
Application No. 09/990,614 is a continuation-in-part of application No. 09/837,738, filed on Apr. 16, 2001.
Application No. 09/990,614 is a continuation-in-part of application No. 09/547,272, filed on Apr. 11, 2000.
Application No. 09/990,614 is a continuation-in-part of application No. 09/547,270, filed on Apr. 11, 2000.
Application No. 09/990,614 is a continuation-in-part of application No. 09/347,389, filed on Jul. 6, 1999, now Pat. No. 6,529,723.

(51) Int. Cl. H04Q 7/20; H04M 1/00; H04B 1/38

(52) U.S. Cl. 455/456; 455/563

(57) ABSTRACT

A system and method for allowing a user to obtain location information for a suitably tagged item, such as a vehicle, without requiring that the user have access to a viewable medium, for example a computer monitor, is provided. The system uses a network operations center that is in communication with one or more remote devices, at least a portion of the communications being wireless. The network operations center is comprised of a processor, data base and transceiver and is preferably capable of fully automated operation, thus eliminating the need for human intervention. The remote devices include a transceiver, controller and location tracking module (e.g., a GPS module) and may further comprise one or more sensors and/or one or more device controllers. The location tracking module determines location coordinates for the remote device, either upon request or upon the occurrence of a preset condition, and provides these coordinates to the network operations center. The network operations center converts the location coordinates to a street map position and provides that street map position in an audible form using the desired audio link to the end user or a designated party (e.g., law enforcement agency).

### CROSS-REFERENCES TO RELATED APPLICATIONS

This application is a continuation-in-part of U.S. patent application Ser. No. 09/990,614 filed Nov. 21, 2001 which is a continuation-in-part of U.S. patent application Ser. No. 09/837,738, filed Apr. 16, 2001, Ser. No. 09/547,272, filed Apr. 11, 2000, Ser. No. 09/547,270, filed Apr. 11, 2000, and Ser. No. 09/347,389, filed Jul. 6, 1999, the specifications of which are incorporated herein by reference in their entirety for any and all purposes.

### FIELD OF THE INVENTION

The present invention relates generally to systems for communicating via a wireless network to selected devices and, more particularly, to a method and apparatus for providing location information via a voice synthesized interface.

### BACKGROUND OF THE INVENTION

A variety of different types of systems utilize a centralized communications to monitor, remotely operate, and otherwise communicate with remote devices. For example, many home and vehicle security systems use a variety of monitors (e.g., door, window, floor pressure, motion, sound, smoke detectors, etc.) that are coupled via a wireless network to a centralized office. In general, the centralized office is staffed around the clock so that when a critical event occurs (e.g., break-in, burglary, fire, etc.) the monitored event can be reported to the suitable parties (e.g., police department, fire department, property owner, etc.).

Unfortunately, there are a number of problems associated with typical monitoring systems. First, it can be difficult to continually update the monitoring service as conditions, such as contact information for the property owner, change. Not only can it be difficult to change such information, the information intake service personnel may make mistakes, leading to the service being unable to locate the property owner in an emergency. Second, the monitoring personnel can make mistakes with respect to a reported incident, for example not noting the occurrence of an event, improperly reporting or delaying the reporting of the event, etc.

With respect to vehicle monitoring systems, it is very important to rapidly and reliably notify the user in the case of an alarm associated with the monitored vehicle. If the alarm is a false alarm, it is generally easily corrected. In the case of a valid alarm indicating that the vehicle is in the process of being stolen, information relating to the car's exact location is critical to the tasks of successfully retrieving the stolen vehicle and apprehending the thieves. In some instances even if the vehicle is not being stolen, the owner may wish to obtain updated location and travel speed, for instance if the vehicle is being used by a friend or relative.

Currently there are systems that report the location of a vehicle once it has been determined that the vehicle has been stolen. In such a system, once an alarm monitor has been triggered, for instance by not deactivating the alarm system prior to starting the car, a location sensor is activated. The location sensor determines the vehicle's location and reports the location via a predetermined protocol. A typical protocol requires that the location information be provided to a local law enforcement agency in order to allow rapid retrieval of the stolen vehicle. Alternately, the protocol may require that the owner be notified of the vehicle's location prior to notifying the police, thus minimizing the risks of false alarms. One method of reporting the vehicle's location is by superimposing the location on a map. Unfortunately, under some circumstances the intended viewer may be unable-to use such a map.

### SUMMARY OF THE INVENTION

The present invention provides a system and method for allowing a user to obtain location information for a suitably tagged item, such as a vehicle, without requiring that the user have access to a viewable medium, for example a computer monitor. The system uses a network operations center that is in communication with one or more remote devices, at least a portion of the communications being wireless. The network operations center is comprised of a processor, data base and transceiver and is preferably capable of fully automated operation, thus eliminating the need for human intervention. The remote devices include a transceiver, controller and location tracking module (e.g., a GPS module) and may further comprise one or more sensors and/or one or more device controllers. The location tracking module determines location coordinates for the remote device, either upon request or upon the occurrence of a preset condition, and provides these coordinates to the network operations center. The network operations center converts the location coordinates to a street map position and provides that street map position in an audible form using the desired audio link to the end user or a designated party (e.g., law enforcement agency).

In at least one embodiment of the invention, a user is able to request the street map position of a remote device via a user-network operations center interface. The system can utilize any of a variety of interfaces, including an Internet site and/or a telephone. In conjunction with a telephone interface, preferably the network operations center utilizes a speech recognition system although automated communications can also utilize the telephone's touch tone pad.

In at least one embodiment of the invention, the street map position of the remote device is provided to the user via a telephone interface, radio line, or other audio based communications link. The interface used to deliver the street map position can be based on the interface used to request the position information, i.e., if the user requests information via a telephone, the information is provided via a telephone. Alternately, the interface can be pre-selected, for example on the basis of the time of day or on the event that triggered the determination of the location (e.g., alarm versus user request). Alternately, the location information can be simultaneously provided on multiple interfaces (e.g., audio, text, and graphics).

In at least one embodiment of the invention, in addition to street map position, the date and time that the position was acquired is also provided to the user.

In at least one embodiment of the invention, in addition to street map position, the travel speed of the remote device is also provided to the user.

A further understanding of the nature and advantages of the present invention may be realized by reference to the remaining portions of the specification and the drawings.

### BRIEF DESCRIPTION OF THE DRAWINGS

FIG. 1 is an illustration of an embodiment of an automated user notification system constructed in accordance with the present invention;

FIG. 2 is an illustration of one embodiment of a remote device in accordance with the present invention;

FIG. 3 is an illustration of a web page used to show the position of a remote device; and

FIG. 4 is an illustration of a preferred embodiment of the user notification system.

### DESCRIPTION OF THE SPECIFIC EMBODIMENTS

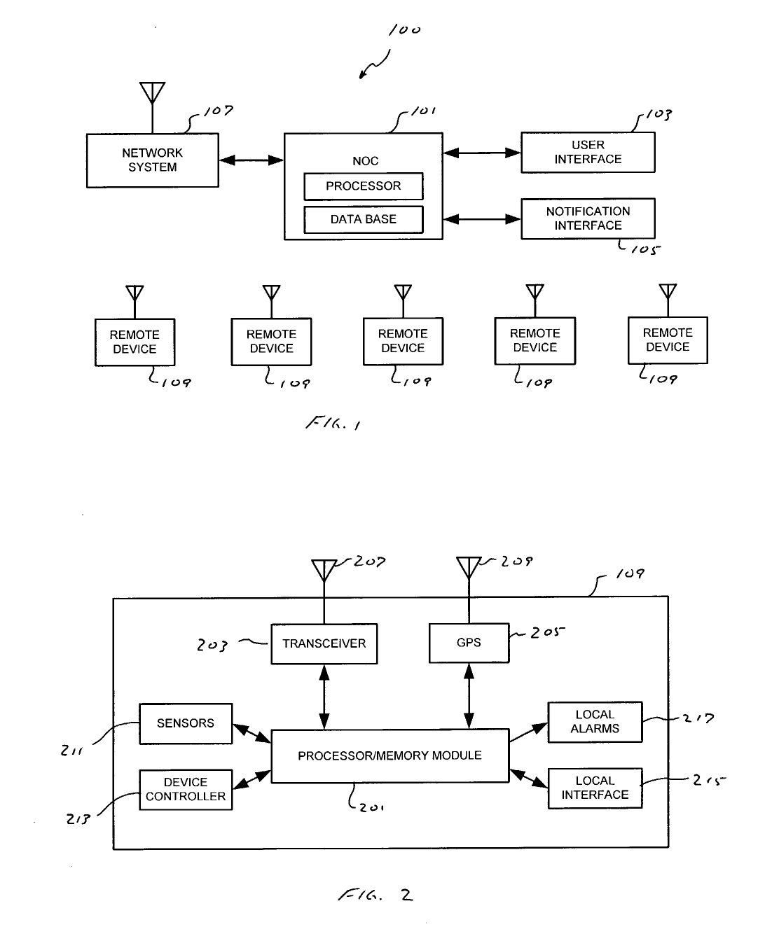

FIG. 1 is an illustration of an embodiment of an automated user notification system 100 constructed in accordance with the present invention. User notification system 100 is comprised of a network operations center (NOC) 101, a user interface 103 and a notification interface 105. NOC 101 is coupled to a communication network system 107, preferably a bi-directional communication network, and more preferably a commercial bi-directional communication network such as that provide by Aeris.net™. NOC 101, via network 107, communicates with a plurality of remote devices 109. Preferably network 107 provides wireless communication to devices 109 although it is understood that either some or all of the remote devices 109 can be coupled to NOC 101 via a wired network.

NOC 101 is comprised of a processor 111 and a database 113. Processor 111 controls the functionality of NOC 101, as further outlined below, and may be comprised of a single processor or multiple processors. Multiple processors may be used to provide system redundancy, to interface with the desired number of remote devices 109, and/or to provide dedicated functionality (e.g., responding to user requests, responding to sensor alerts, billing customers, etc.). Database 113 includes a user database, billing information, response codes and instructions, etc. and is preferably comprised of both volatile and non-volatile memory.

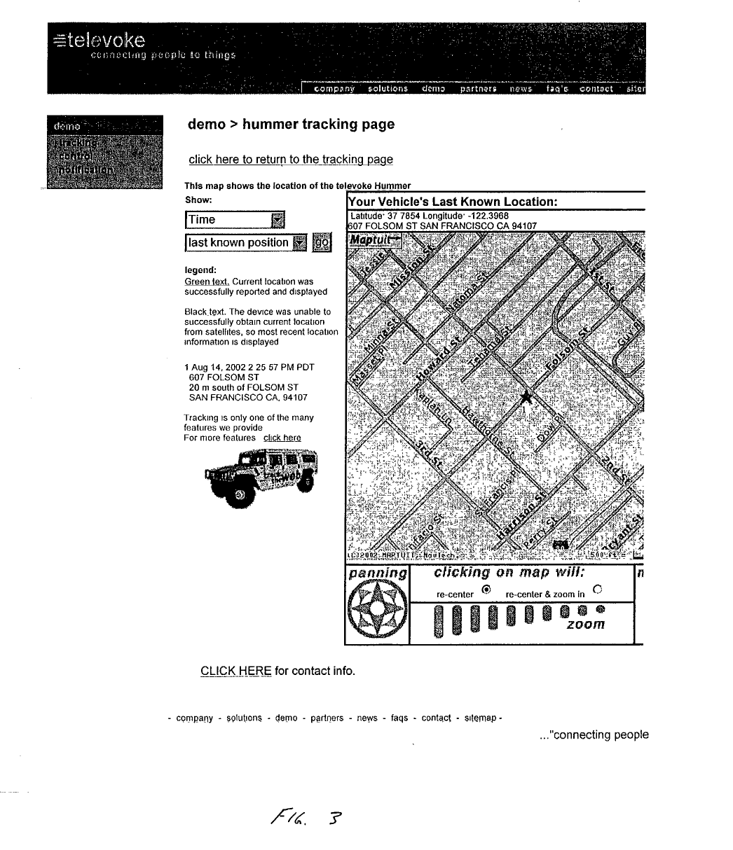

FIG. 2 is an illustration of one embodiment of remote device 109. It is understood that system 100 can be comprised of a plurality of identical or non-identical devices 109, non-identical devices 109 allowing for variations between devices 109 in order to account for user needs, device location, device mounting configuration, sensor type and number, desired device complexity, user interface options, remote functionality, network communications, etc. It is understood that each device 109 is attached to a specific, uniquely identifiable vehicle or other property, or a uniquely identifiable portion of a larger article.

Regardless of the type or desired functionality of device 109, each such device includes a controller 201, typically comprised of a processor and a memory module, and a transceiver 203 that allows device 109 to communicate via network 107 with NOC 101. Device 109 also includes a global positioning system (GPS) module 205. In general, transceiver 203 and GPS module 205 will utilize separate antennae, 207 and 209 respectfully, although it will be appreciated that both modules can utilize a single antenna.

In a preferred embodiment, device 109 also includes one or more sensors 211 which can sense a variety of conditions relating to the vehicle to which it is attached. For example, sensors 211 may include motion sensors, door sensors (e.g., door opened/closed), door lock sensors, window sensors (e.g., window opened/closed), car roof status (e.g., convertible up/down, sun-roof opened/closed), light sensors (e.g., lights on/off), engine status sensors, speed sensors, occupant sensors (e.g., pressure sensors located within the vehicles seats), etc. Sensors 211 may also utilize an Intelligent Data Base or IDB. The IDB is a peer to peer data network available for use in automotive devices and other ground vehicles which has access to important vehicle systems, such as the vehicle's electrical system and components. Sensors 211 may also utilize an On-Board Diagnostic system or OBD. The OBD system provides a means of diagnosing engine problems and controlling engine functions.

In a preferred embodiment, device 109 also includes one or more device controllers 213. Controllers 213 can be used to control various functions of the systems to which they are attached. For example, controllers 213 can be used to remotely lock/unlock doors, close/open windows, close/open convertible top, close/open sun-roof, turn on/off lights, enable/disable engine, enable/disable ignition switch, activate a cellular phone within the passenger compartment of the vehicle, etc.

In at least one embodiment of the invention, device 109 also includes a local interface 215. Local interface 215 is preferably comprised of a keypad or other switching means. Additionally, local interface 215 preferably includes one or more indicators, visual, audible, or both. Local interface 215 can be used to control the status of device 109 (e.g., on/off), allow for local emergency activation (e.g., panic switch), and/or allow for direct user/NOC communications (e.g., for user requested directions, addresses, telephone numbers, etc.).

In at least one embodiment of the invention, device 109 also includes one or more localized alarms 217 which can be activated prior to, simultaneously with, or after a notification alert or other message is sent to NOC 101 by device 109. Alarms 217 can include a separate horn or other sounding device or alarm 217 can simply activate the vehicle's horn. Additionally, alarms 217 can include a relay switch coupled to the lights, thus allowing for the activation of some or all of the vehicle's lights, either continuously or intermittently.

Device 109 can interact with NOC 101 in a variety of ways and in response to a variety of conditions. Once notified of a specific condition, NOC 101 can notify the user, police, fire department, paramedics, or other parties based on the preprogrammed notification instructions contained within NOC 101. Additionally, NOC 101 can be configured to send a response directly to device 109 (e.g., disable engine, honk horn, flash lights, lock doors, determine and send position coordinates, etc.). A few examples of system operational modes are provided below although it will be appreciated that these are only meant as examples and that there are other uses for the disclosed system.

Alarm mode: Preferably system 100 is configured to provide alarm functionality. Specifically, device 109 is preferably configured to notify NOC 101 whenever there is an occurrence of a predetermined alarm event (e.g., vehicle break-in, vehicle movement, fire, etc.). Sensors 211 detect the alarm event, for example by monitoring the condition of the doors, windows, engine, ignition switch, seat pressure, vehicle movement (e.g., speed or positional changes), engine tachometer, smoke detectors, CO₂ detectors, etc.

Notification mode: System 100 can be configured to notify NOC 101 upon the occurrence of a specific condition. For example, the user may set-up the system to send a notification message whenever the vehicle exceeds a predetermined speed, leaves a predetermined geographic region, or is started between the hours of midnight and 4 AM. Alternately, the system can be configured to send a response to the local system and notify the user immediately upon the occurrence of the specified condition. For example, if a sensor within device 109 determines that the vehicle to which device 109 is attached is exceeding a predetermined speed, the system can notify the user and also direct device 109 to employ a speed limiter. Alternately, the system can be configured to send a notification and response, either simultaneously, serially or in a predetermined timed sequence, upon the occurrence of the specified condition.

NOC 101, through notification interface 105, is configurable and programmable to utilize a variety of different notification devices, the notification devices allowing communication with end users (e.g., notifying an end user that an alarm condition has been detected). In the preferred embodiment, NOC 101 automatically responds to a preprogrammed condition or occurrence (e.g., a detected alarm condition on a specific device 109), thereby not requiring human operator instructions or other human interaction. Accordingly, in the preferred embodiment, interface 105 is coupled to electronic mail (i.e., e-mail), facsimile, pager and/or standard telephonic devices. In order to utilize standard telephonic devices in the preferred automated system, interface 105 includes a voice synthesis system. Additionally interface 105 of the preferred embodiment is coupled to a public data network, such as the Internet, thus allowing notification messages to be sent by e-mail as well as through page updates on a secure, user-accessible WEB site.

User interface 103, coupled to NOC 101, allows end users to access and control the operation of NOC 101. In the preferred embodiment, interface 103 allows at least limited user/NOC communications without the need for a human operator. Preferably interface 103 is coupled to the Internet, thus allowing user access via e-mail and/or WEB site manipulation. Additionally, interface 103 can be coupled to a public or private telephone system. In order to allow automated operation, the telephone system preferably includes a voice recognition system although a simple tone recognition system can also be used. Preferably system 100 is configured to allow users, through user interface 103, to obtain status information about a user item to which a device 109 is coupled (e.g., determine if the doors are locked), to enable/disable specific sensors 211, to control specific subsystems of the vehicle to which device 109 is attached (e.g., door locks), to reprogram aspects of device 109, to revise notification instructions, to revise contact information, to revise sensor alarm conditions, to obtain billing information, etc., all without the need for human operator assistance.

As previously disclosed, the present invention can utilize both wireless and wired communication channels. In the preferred embodiment, a wireless system is used in which the data flowing between NOC 101 and devices 109 (e.g., detected events, status checks, equipment control, etc.) is sent as data packets over existing cellular networks. In one preferred embodiment, network system 107 is comprised of the Aeris.net™ network and the data packets are sent using the Aeris.net™ MicroBurst® technology. It will be appreciated that other technologies can be used to send and receive the data packets of the present invention. For example, VBurst® technology can be used with the Aeris.net™. Alternately, the present invention can utilize the control channel of the AMPS analog cellular phone system for the communication link between remote devices 109 and NOC 101. Other alternate wireless communication systems include the GSM cell phone system which supports SMS (i.e., short message service) for the bi-directional delivery of data; the Mobitex™ data message delivery system offered in the Erricson and Bell South systems; the Ricochet™ brand of data transceivers offered by Metricom; and other cellular systems supporting such formats as the CDPD standard of wireless messaging. Satellite based wireless systems such as the ORBCOM™ system by Orbital Sciences Corporation can also be used to link remote devices 109 to NOC 101. Wired communication channels include analog phone lines, ISDN phone lines, T1 phone lines, and DSL phone lines. An alternate to any of the public carrier systems is a private data network.

As the above-identified communication systems are well known, including the preferred Aeris.net™ system, a detailed description of the required controllers, data routers, firmware, standardized protocols, etc. is not provided herein. It is understood, however, that transceiver 203 and controller 201 of each device 109 includes the necessary firmware/software to achieve compatibility with network 107 (e.g., receive, decode and execute instructions originating at NOC 101, code and transmit information for use by NOC 101, etc.).

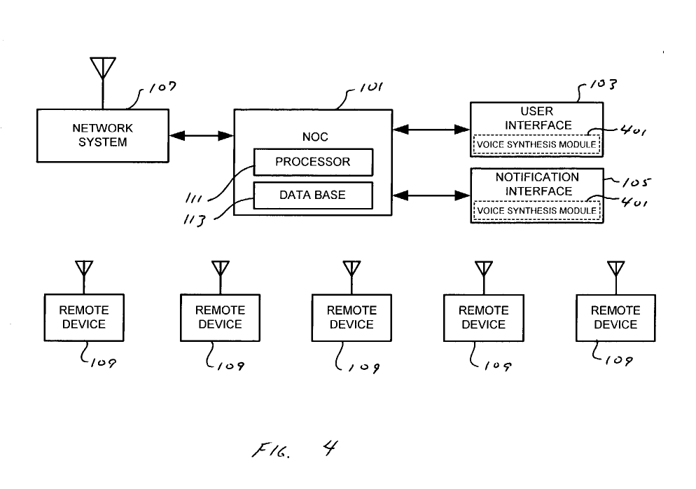

As disclosed above, system 100 allows a user to communicate with NOC 101 either through user interface 103 or through notification interface 105. Regardless of the interface used to communicate with NOC 101, the user can obtain or can be provided with location information for a specific remote device 109, assuming that the remote device in question includes GPS module 205 (or other location sensing means) as described above. In a typical configuration, location information is provided on a map via a graphical interface. Thus, for example, the user may request the location of a specific remote device 109 via an Internet web site. The user would then be presented with a map, such as that shown in FIG. 3, on which the location of the remote device in question is indicated. In accordance with the invention, however, this same information can be provided via a synthesized voice interface.

FIG. 4 is an illustration of system 100 in accordance with a preferred embodiment of the invention. In this embodiment, user interface 103, notification interface 105, or both interfaces include a voice synthesis module 401. Voice synthesis module 401 is used to present information to an end user or a party designated by the end user (e.g., police department), the presented information including at least remote device location information. As a result of module 401, the intended recipient of the location information does not have to have access to a graphical display device (e.g., computer monitor) in order to obtain the desired information.

In a preferred embodiment, when location information is requested, either by the user or by the system in response to a preset condition, NOC 101 obtains position information from the GPS module 205 coupled to the remote device 109 in question. Typically the initial position information is provided in terms of latitude and longitude coordinates. Although the actual latitude and longitude coordinates can be provided to the user, preferably mapping software is used to determine more user-friendly position information wherein the position information is provided in terms other than latitude and longitude coordinates. For example, the mapping software can utilize reverse geo-coding technology to provide the street location corresponding to the determined GPS coordinates.

Depending upon the desired interface, the location of the remote device (e.g., corresponding street location) can be presented graphically (e.g., as a location on a map), textually (e.g., as a description of the location) or verbally (e.g., as an audio description of the location). Typically the graphical presentation is preferred when the user has access to a monitor (e.g., an Internet coupled computer), the textual presentation is preferred when the user has access to a wireless handheld capable of e-mail communication, and the verbal presentation is preferred when the user is limited to a public or private telephone system or other audio based means (e.g., police transceiver). Thus, for example, if the remote device were located at a latitude of 37.7854 and a longitude of −122.3968 as determined by GPS module 205, the preferred graphical presentation of these coordinates is shown in FIG. 3. Preferably the user is able to alter the amount of map coverage surrounding the location, for example by zooming in or out on the coordinates. Alternately, these same coordinates could be e-mailed or otherwise textually provided to the user. In this instance these coordinates could be presented as the message

607 Folsom St

San Francisco, Calif. 94107

or

20 m south of Folsom St

San Francisco, Calif. 94107

or

Between 600 and 700 Folsom St

Near the intersection of Folsom St and 2^{nd} St

San Francisco, Calif. 94107

Alternately, the textual message can be converted to an audible message by passing the textual message through a voice synthesizer, e.g., voice synthesis module 401. Once converted, NOC 101 can play the audio message, for example using a simple audio card such as those manufactured by the Dialogic division of the Intel Corporation. The synthesized audio message can be transmitted to the intended recipient over a public or private telephone system or other means. It will be appreciated that the above text/audio messages are meant to be illustrative, not limiting, as to the form that such communications may take.

In an alternate embodiment of the invention, conversion of the location coordinates to a street map position and then to an audio message is done within the controller residing within the remote device 109. Preferably in this embodiment transceiver 203 is capable of communicating directly with the user and delivering the audio message containing the street map position, thus not going through NOC 101.

Preferably regardless of the technique used to present the location information to the user, the date and the time that the location of the remote device was acquired is also provided to the user. Thus on the graphical display, the date and time of acquisition can be shown along with the map. In a text or audio message, the acquisition date and time can precede or follow the location information. Similarly, in another preferred embodiment, the speed at which the remote device is traveling is provided to the user along with the location information.

In a preferred embodiment of the invention, when the user sets-up the system, he or she also sets the preferred interface. Thus the user is able to set-up the system to send notification messages, and in particular those providing location information, using a graphical interface, a textual interface, or an audio interface.

In another preferred embodiment, the system sets the interface based on a set of predetermined conditions. Preferably the user sets the predetermined conditions. For example, the user may specify that location information is to be provided using a graphical interface during the user's normal business hours (e.g., 8-5 PST) and using a audio interface during all other hours. Alternately, the user may specify that the location information should be provided via graphical interface first, but if confirmation of receipt of the information is not received within a preset period of time (e.g., 5 minutes), the location information should be resent using an audio (or textual) interface. If desired, the user can cycle through all three interfaces rather than just two (e.g., graphics first, if no confirmation, text, if no confirmation, audio). This approach insures that the user obtains the desired location information in the best possible format based upon the user's presently accessible interface. Alternately, the system can be configured to simultaneously send location information using.multiple interfaces (e.g., graphic, text and audio), thus insuring that the user is able to access the information using some interface. Alternately, the interface can be configured to select the interface based on a set of triggering events. For example, NOC 101 can be configured to send an audio message containing location information to a local law enforcement agency if an alarm is received from the remote device (e.g., unauthorized use, leaving a preset geographical region, exceeding a preset speed) and to otherwise send the location information graphically. Alternately, NOC 101 can be configured to respond to a request for location information based upon the format of the request. Thus, for example, if the user requests location information using a telephone interface (either using the phone's keypad or a using a voice recognition module within NOC 101), the location information would be provided using the audio interface. If, on the other hand, the user requests the information via a web site, NOC 101 would provide the location information graphically.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A method of communicating location information to a user, wherein said location information corresponds to a specific remote device, the method comprising the steps of:
selecting said specific remote device from a plurality of remote devices;
determining a set of location coordinates corresponding to said specific remote device;
converting said set of location coordinates into a text message;
converting said text message into an audio message; and
transmitting said audio message to the user via an audio link.

2. A method of communicating location information to a user, wherein said location information corresponds to a specific remote device, the method comprising the steps of:
selecting said specific remote device from a plurality of remote devices;
determining a set of location coordinates corresponding to said specific remote device, wherein said set of location coordinates are comprised of a latitude coordinate and a longitude coordinate;
determining a street map position corresponding to said specific remote device and to said set of location coordinates;
converting said street map position into a text message;
converting said text message into an audio message; and
transmitting said audio message to the user via an audio link.

3. The method of claim 2, further comprising the step of transmitting a request for said set of location coordinates from an automatic network operations center to a controller coupled to said specific remote device via a first communication link, wherein said automatic network operations center is remote from said controller and said specific remote device, and wherein said controller determines said set of location coordinates.

4. The method of claim 3, wherein said steps of selecting said specific remote device, transmitting said request, determining said set of location coordinates, determining said street map position, converting said street map position, converting said text message, and transmitting said audio message are performed without human intervention.

5. The method of claim 4, wherein said steps are performed automatically.

6. The method of claim 3, further comprising the steps of:
inputting a position request to a user interface, wherein said user interface is remotely located from said automatic network operations center; and
transmitting said position request to said automatic network operations center via a second communication link; and
receiving said position request by said automatic network operations center, wherein said step of transmitting said request for said set of location coordinates by said automatic network operations center is in response to said receiving step, and wherein said receiving step and said step of transmitting said request occur automatically without human intervention.

7. The method of claim 6, wherein said second communication link includes at least one wireless link.

8. The method of claim 3, wherein said step of transmitting said request for said set of location coordinates by said automatic network operations center is in response to an occurrence of a preset condition.

9. The method of claim 8, further comprising the steps of:
monitoring said specific remote device by said automatic network operations center; and
determining the occurrence of said preset condition by said automatic network operations center, wherein said steps of monitoring and determining the occurrence of said preset condition occur automatically without human intervention.

10. The method of claim 3, further comprising the step of transmitting said set of location coordinates to said automatic network operations center by said controller, wherein said steps of determining said street map position, converting said street map position, converting said text message and transmitting said audio message are performed by said automatic network operations center.

11. The method of claim 2, wherein said step of determining said set of location coordinates corresponding to said specific remote device is performed by a GPS module coupled to said specific remote device.

12. The method of claim 2, further comprising the step of transmitting said audio message to a party designated by the user via a second audio link.

13. The method of claim 2, further comprising the steps of:
determining a location acquisition time;
converting said location acquisition time into a second text message;
converting said second text message into a second audio message; and
transmitting said second audio message to the user via said audio link, wherein said second audio message is transmitted in conjunction with said first audio message.

14. The method of claim 2, wherein said street map position is comprised of an approximate location on a named street.

15. The method of claim 2, wherein said street map position is described relative to a street intersection.

16. The method of claim 2, wherein said audio link is a public telephone system.

17. The method of claim 2, wherein said audio link is a private telephone system.

18. The method of claim 2, wherein said audio link is an RF link.

19. The method of claim 2, further comprising the steps of:
determining a speed of travel corresponding to said specific remote device;
converting said speed of travel into a second text message;
converting said second text message into a second audio message; and
transmitting said second audio message to the user via said audio link, wherein said second audio message is transmitted in conjunction with said first audio message.

20. A system for providing location information to a user, the system comprising:
at least one remote device;
a GPS module directly coupled to said at least one remote device, wherein said GPS module generates a set of location coordinates corresponding to a position of said at least one remote device;
a first transceiver directly coupled to said at least one remote device, said first transceiver receiving instructions and transmitting said set of location coordinates; and
an automatic network operations center operating automatically without human intervention, said automatic network operations center comprising:
a second transceiver in communication with said first transceiver via a wireless link, said second transceiver transmitting instructions and receiving said set of location coordinates;
means for mapping said set of location coordinates to a street map position;
means for converting said street map position to a text message;
a speech synthesizer for converting said text message to an audio message; and
a user interface, wherein said audio message is transmitted to said user interface by said automatic network operations center via a communication link.

21. The system of claim 20, wherein said communication link is a telephone system.

22. The system of claim 20, wherein said communication link is an RF link.

23. The system of claim 20, further comprising a speed sensor directly coupled to said at least one remote device and transmitting a speed of travel of said at least one remote device to said automatic network operations center using said first and second transceivers, wherein said automatic network operations center further comprises means for converting said speed of travel to a second text message, wherein said speech synthesizer converts said second text message to a second audio message, and wherein said second audio message is transmitted to said user interface by said automatic network operations center via said communication link.

24. The system of claim 20, further comprising an acquisition time sensor directly coupled to said at least one remote device and transmitting an acquisition time corresponding to a time of acquiring said set of location coordinates to said automatic network operations center using said first and second transceivers, wherein said automatic network operations center further comprises means for converting said acquisition time to a second text message, wherein said speech synthesizer converts said second text message to a second audio message, and wherein said second audio message is transmitted to said user interface by said automatic network operations center via said communication link.

25. The system of claim 20, said automatic network operations center further comprising an acquisition time sensor for generating an acquisition time corresponding to a time of acquiring said set of location coordinates, wherein said automatic network operations center further comprises means for converting said acquisition time to a second text message, wherein said speech synthesizer converts said second text message to a second audio message, and wherein said second audio message is transmitted to said user interface by said automatic network operations center via said communication link.
